(19) United States
(12) Patent Application Publication
(10) Pub. No.: US 2011/0029393 A1
(43) Pub. Date: Feb. 3, 2011

(54) Method and System for Tracking Interaction and View Information for Online Advertising

(75) Inventors: Joseph T. Apprendi, Montclair, NJ (US); Christopher M. Putnam, Montclair, NJ (US)

Correspondence Address: MORGAN, LEWIS & BOCKIUS LLP, 1701 MARKET STREET, PHILADELPHIA, PA, 19103-2921, US

(73) Assignee: Collective Media, Inc., New York, NY (US)

(21) Appl. No.: 12/832,520

(22) Filed: Jul. 8, 2010

Related U.S. Application Data
(60) Provisional application No. 61/224,127, filed on Jul. 9, 2009.

(51) Int. Cl. G06Q 30/00

(52) U.S. Cl. 705/14.73

(57) ABSTRACT

An advertising unit is intended for display on a web page. The advertising unit has a size and a position relative to other objects within the web page. An identifier associated with an instance of the advertising unit displayed on the web page is generated. Upon receiving an indication that the web page has been loaded in the browser, engagement tracking module identifies the advertising unit within the page based on the size of the advertising unit, the position relative to other objects within the web page, and the identifier and tracks data regarding engagement with the advertising unit by a user of the browser.

### CROSS REFERENCE TO RELATED APPLICATIONS

This application claims the benefit of the U.S. Provisional Patent Application No. 61/224,127 filed on Jul. 9, 2009, which is hereby incorporated by reference in its entirety.

### FIELD OF THE INVENTION

The present invention relates to tracking information relating to viewing and interacting with advertising presented over a communications network.

### SUMMARY OF THE INVENTION

The present invention is directed to a system, method and computer readable storage medium for tracking metrics relating to viewing and interacting with online advertising (such interaction and viewing of advertising herein referred to as “engagement”). A request for an advertising unit to be displayed on a web page is received at a server from a web browser. The advertising unit has a size and a position relative to other objects within the web page. An identifier associated with an instance of the advertising unit displayed on the web page is generated. A response is returned to the web browser. The response includes an engagement tracking module. Upon receiving an indication that the web page has been loaded in the browser, the engagement tracking module identifies the advertising unit based on the size of the advertising unit, the position relative to other objects within the web page, and the identifier and tracks data regarding engagement with the advertising unit by a user of the browser.

It is to be understood that both the foregoing general description and the following detailed description are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an exemplary web page displaying an ad unit;

FIG. 2 illustrates an exemplary system diagram used to implement the present invention;

FIG. 3 illustrates an exemplary method of the present invention; and

FIG. 4 is an exemplary report of the present invention.

### DETAILED DESCRIPTION

Reference will now be made in detail to the embodiments of the present invention, examples of which are illustrated in the accompanying drawings. Wherever possible, like reference numbers will be used for like elements.

The methods and systems described herein pertain to tracking metrics related to the interaction with, and viewing of, advertising units (referred to herein as “ads”) delivered in an online environment (e.g., over the Internet). Some existing Rich Media advertising technology allows for certain engagement metrics to be tracked and reported. However, such existing technology only works for advertisements displayed using Rich Media. In contrast, the methods and systems described herein provide for the tracking of metrics regardless of the technology used to display the ads. For example, the systems and methods work with any display object within a web page, including standard static banner ads (e.g., an IMG tag), ads within an IFRAME or FORM tag, or Rich Media ads within an OBJECT or EMBED tag.

The following provides a general description of one exemplary embodiment of the way in which the system captures engagement metrics. A Javascript ad tag is used to load the ad into the page. This is implemented in the page (or the publisher's upstream ad server) as a <script> tag, where the SRC parameter (i.e., the source URL of the image) is a URL on the host ad servers. The host server returns Javascript library code and then executes a function from the library to initialize the engagement tracking module (i.e., the module used to track metrics related to the interaction with and viewing of ads). The ad is loaded from the downstream ad server, which may be an image, a Rich Media object (e.g., Flash SWF), or an IFRAME, by way of example, containing the ad creative. Alternatively, the ad may be loaded from a third party server via a separate tag adjacent to the ad tag on the page. The Javascript code waits until the page has been loaded, and then finds the ad that was loaded. It does this by looking for an OBJECT, IFRAME, IMG, EMBED or FORM of the correct size within the same DOM container object as itself, or within a DIV child of the DOM object. When the Javascript code has identified the ad, it installs event handlers which monitor the engagement metrics for the ad, and then sends logs to the host server recording those metrics. Regardless of the creative type used, OBJECT, IFRAME, EMBED, FORM and IMG tags are all DOM container objects that have a fixed size and position, and respond to mouse events, and can therefore be treated in the same way with respect to monitoring position, visibility, and interaction.

As used herein, “engagement” relates to metrics that measure the time spent viewing and/or interacting with an ad, and the number of interactions with that ad. Some of the individual reportable metrics include, but are not limited to:

Interaction count (IC: number of interactions per impression). An ad impression is a single display of a single ad unit within a web page. An impression is counted when an ad is loaded into the page, whether or not the ad is actually visible in the browser. An interaction is counted each time the user moves the mouse pointer within the bounds of the displayed ad. If the user moves the mouse out of the ad display area, and then back into it, another interaction is counted.

Interaction flag (IF: will be 1 if there is any interaction at all, per impression). Interaction time (IT: the total time spent interacting with an ad). Interaction time is the cumulative time (stored internally in milliseconds) that the mouse pointer was within the area occupied by the ad.

View count (VC: 0 if never viewed, 1 if viewed at all, including partial view). A view is counted if any part of the ad was visible within the viewable area of the browser (otherwise known as the viewport) at any time. A full view means that the ad was completely visible at some point.

View time (VT: the total time in seconds that the ad was visible on the page. This timer is capped, e.g., at 2.5 minutes, in one embodiment).

Full View count (FV: 1 if the ad was fully visible at any point).

Above-The-Fold (ATF: View count; 1 if the ad was fully visible on page load). Above-the-fold view means that the ad was fully visible at the time the page was first loaded.

Interaction rate (IR: IF/number of impressions, expressed as a percentage).

Total Interaction rate (IR: IC/number of impressions, expressed as a percentage).

View Rate (VR: VC/number of impressions, expressed as a percentage).

Cost Per Interaction (eCPI: gross revenue/interactions×1000).

Cost Per View (eCPV: gross revenue/views×1000).

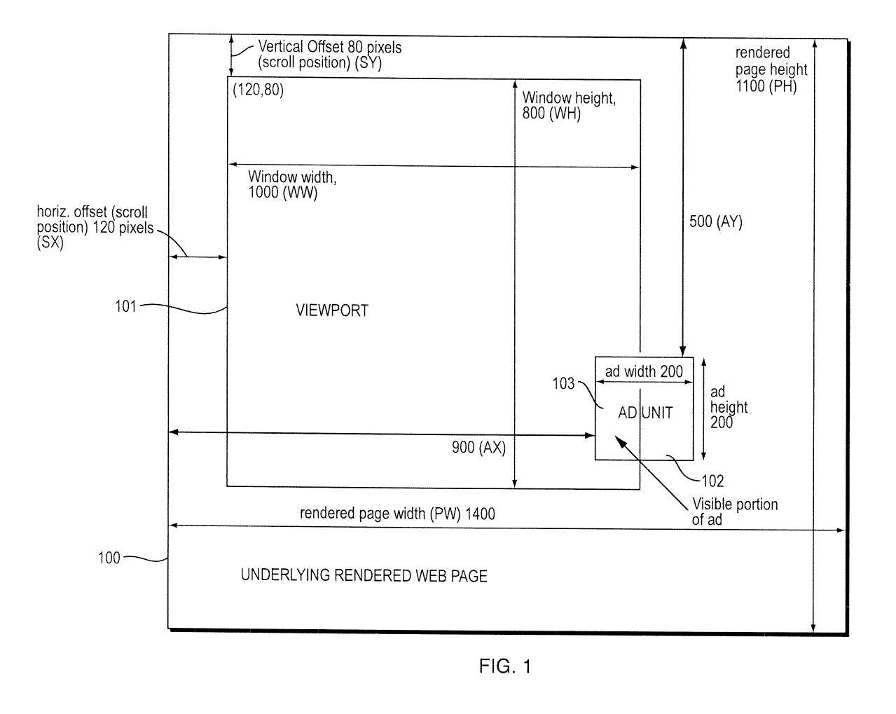

Ad visibility is determined by calculating the size of the browser window (i.e., viewport) and the scroll position offset of the page, and then determining if the coordinates of the ad on the page fall into the viewable area of the page. For example, FIG. 1 shows an underlying rendered web page 100, with an offset viewport 101, and a partially visible ad unit 102 (section 103 of ad unit being visible). Note that the measurements shown in this example are in pixels and are not to scale. In this illustration, the viewport 101 is scrolled to offset of (x−120, y−80). The ad unit is 200×200 and rendered at (x=900, y=500). The relative coordinates of the ad 102 in the viewport 101 are (AX−SX, AY−SY), i.e., (880, 420). Visible ad pixels are therefore (1000−880=120) horizontally and (800−420=380) vertically. Because 380 is greater than the 200 pixel ad height, the ad 102 is completely visible vertically, but partially visible horizontally.

An overview of an exemplary implementation for the methods and systems described herein is now provided. Javascript is the language used for the engagement tracking module in one embodiment because it is currently the most widely supported browser-based client-side programming language that allows access to the underlying structures of the web page. However, other programming languages can be used within the scope of the present invention. The Javascript engine implements a model of the rendered web page called the Document Object Model (DOM), a hierarchical model that contains objects corresponding to all elements in a document, including of all their attributes (e.g., width, height) and also allows for the capture of events related to the user's interaction with the web page (e.g., clicking, dragging, scrolling). The engagement tracking module can run in any web browser that supports the Javascript language and the DOM. This includes, but is not limited to, Internet Explorer, Firefox, and Safari, on both Macintosh and PC platforms.

The engagement tracking module can be loaded from existing ad tags without requiring additional code on the publisher's site. The additional code to execute the engagement tracking module is loaded into the web page dynamically during the loading of the ad. Therefore, any existing ad tag on the publisher's page can also load and run the engagement tracking module with no external code changes necessary on the publisher's side.

Additionally, the engagement tracking module may be loaded from a separate URL in a script tag on a web page or in an ad's creative code, such that this mechanism can be used by third parties to track engagement in ads that are not served from the host's own ad server. This method would be used by advertisers (or their agencies) who wish to track engagement data on their ads, even when those ads are being loaded from a different ad network, and for publishers not on the host network.

The following provides a further description of the method for implementing an embodiment of the engagement tracking system and method. Ad tags on a web site or in a third party ad server load Javascript from server APIs. The server returns Javascript code, with a content-type of application/x-Javascript, which will ultimately result in an ad being displayed. The server then returns a Javascript code library. Javascript code library defines a class which contains the functionality and data required to find a displayed ad on the web page, and track events related to it. An object of this class is instantiated for every ad being tracked on a page. After downloading the library, the script calls a function in the library to instantiate an object of the class and initialize it with the URL of the ad to be loaded, the dimensions of the ad, and a unique transaction identifier generated by the server. The width and height of the ad passed as parameters into the initialization function are the same as the original width and height passed to the ad tag. The unique transaction identifier is generated by the ad server and is used to uniquely identify the ad impression, and allow multiple engagement logs to be collated at a later time and matched up to other ad server impression logs for reporting purposes.

In one embodiment, the unique transaction identifier is generated on the server by concatenating the server's IP address, the current process id number, and the number of milliseconds since midnight. Other manners of generating the unique transaction identifier will be known in the art and are within the scope of the present invention. All resulting identifiers will be unique within a calendar day, within this embodiment, as logs are processed daily.

The function then adds a new Javascript object to the page DOM which will load the ad. The SRC parameter of this new Javascript object is set to a URL that will load an ad from an ad server. An event handler is then installed (i.e., a Javascript API is called to register a function that will be called by the web browser's Javascript engine when a certain event occurs). An event handler is a callback function that is executed in response to a software generated event or message indicating that a certain action has occurred and containing information about that action. In this context, an event may be sent because, for example, the containing web page has been completely rendered, because the user passed the mouse over the ad, and so on. The event handler executes when the page loading completes (i.e., the software generally suspends itself until the web page, including the ad, has been loaded completely, and then continues initialization). When the page load completes, the object locates the ad, identifying it by a combination of its size, transaction identifier, and position in the DOM relative to the original script. When the ad has been found, the event handler is installed to capture activities such as mouse in and out, page unload, focus change, click, scroll and resize, as described below. In particular, interaction counts are added as the mouse moves in and out of the ad. One interaction is recorded by incrementing a Javascript variable every time the mouse enters and then leaves the ad space. Time spent interacting with the ad is captured by starting a timer when the mouse enters the ad and stopping the timer when the mouse leaves. The position of the ad on the page is determined on start up, and then whenever the user scrolls or resizes the page.

As the ad is determined to be visible, because its current coordinates are partially or fully within the visible coordinates of the web page, that data is tracked, and a timer is used to track the amount of time that an ad has been displayed in the viewable portion of the page. When the ad is scrolled out of view, the view timer stops. A dummy image tag is programmatically added to the page DOM at the end of the body tag (the top most containing element of the rendered web page in the DOM), and used to send log data back to a second server. When a log event occurs, the SRC URL of the image is updated with the URL of the log transaction, which causes the request to be sent to the server and logged. The transaction identifier is included in the log data. Logs are sent when the page is loaded, when ads are first determined to be viewable, when the ad goes out of view, and when the page is being unloaded. Multiple logs are sent to reduce the chances for missing data because of failed network connections and other reasons.

An example of the details used in connection with implementing the systems and methods described herein are now described. As will be understood by those skilled in the art variations on such implementations can be made, within the scope of the present invention.

The Javascript ad tags on publisher's page, or ad server, request the ad, as provided in the following example:

<script src=”a.hostentity.net/adj/cm.sitename/;sz=728×90;”></
script>

The server returns Javascript code containing an engagement class and function library containing:
a class (_heIV, which stands for Host Entity Interaction and View), which is instantiated once per ad unit on a page;
a bootstrapping function createAndAttachAd( ) which is used to instantiate and initialize an instance of the _heIV class; and
a CALL to the bootstrapping function.

The bootstrapping function is called, passing parameters:
unique transaction ID
URL of the downstream ad tag
ad unit width in pixels
ad unit height in pixels

The bootstrapping function performs the following tasks:
Determines the browser type and, thus, the supported Javascript APIs
Iterates backwards through the SCRIPT objects in the DOM to find a DOM pointer to itself. The last script in the DOM list of scripts will be the currently executing script. Once found, this script pointer is saved in a variable.
Programmatically create a new script element (at the current position in the DOM) to load the ad tag from the downstream server:

```
    var scr = document.createElement(‘script’);
    scr.language = ‘Javascript’;
    scr.setAttribute(‘type’,‘text/Javascript’);
    var str = “”;
    str += “document.write(‘<scr‘+’ipt language=\“Javascript\”
    src=\“”+url+“\”></scr‘+’ipt>’);”;
    thisScript.parentNode.insertBefore(scr,thisScript);
    appendChild(scr,str);
Instantiate_heIV class object
    var x = new heIV_( );
Call the init( ) method of the new object, passing in the transaction
identifier, script pointer, width and height
```

In connection with initialization of the _heIV Object, parameters are stored. An event handler is stored that will respond to the page onLoad event, which is a member method of the current object:

if(window.addEventListener){ // Mozilla, Netscape, Firefox
window.addEventListener(‘load’, this.onLoad, false );
...

With regard to the page load event handler, initialization continues during the page onLoad event. This event is chosen because at this point the page has completely loaded, and therefore it is not possible for the engagement tracking code to cause any negative effects on the content or ads loaded on the page. That is, any potential delays caused by the engagement code execution, or logging network connections, will not prevent objects on the page from being loaded, and thus adversely affect either the user experience, or the loading of ads.

If the engagement logging servers were not responding, this would cause a network connection to be occupied temporarily while waiting for a server to respond, or for the timeout period to elapse before giving up. In such a scenario, a computer with limited network connections available would have to wait for the blocked connection to become free, which would slow down the loading of objects on the web page. By waiting until all objects are loaded, this potential problem is avoided.

The onLoad handler functions by iterating backwards (i.e., most recent first) through the sibling objects of the current script, one of which will be, or contain, the ad. A sibling object is an object with the same parent in the hierarchical DOM model. The onLoad handler then tests the type of each object to determine if it is a possible ad, for example, an anchor (A), IFRAME, EMBED or OBJECT. An ad object that has been loaded by an ad tag at the current DOM level will appear in that level, and will have characteristics that can be used to identify it, including the width, height, URL, and presence of a unique transaction identifier in the ad or click through URL. When a DIV or other container tag is found, the function will recursively iterate through the children until the ad is found.

An anchor (A) tag, containing an image (IMG) tag will be loaded for the simplest type of banner ad. The anchor will contain the click URL in its HREF property. An IFRAME is an inline frame containing a separate HTML document which in turn contains the ad. The IFRAME's width and height matches the width and height of the ad, and the IFRAME SRC URL may include the transaction ID for further identification. An OBJECT tag loads a Flash object (SWF) and, again, has width and height dimensions that match the ad tag dimensions. When an appropriate type of object has been found, it can be verified by matching up its width and height to those passed in as parameters to the initialization function, and/or the existence of the transaction identifier in the click URL.

A transaction identifier may be generated for each ad impression. The transaction identifier is a string of letters and/or numbers unique to that impression which may be matched, such that multiple ads loaded into the same page each have different identifiers. When positively identified, a pointer to the ad object is stored in a variable. A dummy 1×1 pixel image is appended to the body of the document. This IMG tag is given an identifier based on the transaction identifier, and will be used to log engagement data to a remote server. The image is appended to the document body programmatically as follows:

var img = document.createElement(‘IMG’);
img.height = 1;
img.width = 1;
img.id = “img”+me._id;
document.body.appendChild(img);

Initialization continues by installing event handlers for the following events:
window.beforeunload
window. blur
window. focus
window. unload
window. scroll
window. resize
ad_object.mouseover
ad_object.mouseout
ad_object.click
timer

The dummy IMG tag mentioned above is used to send logs to the server, by programmatically setting its SRC (the source URL of the image) property to a new URL. Setting this property causes the image to load the new URL immediately, which sends a request to the logging server containing the log data in the URI, which is then recorded to a log file, and the server responds with a 1×1 pixel GIF image to satisfy the HTTP request. Setting, or re-setting, the SRC property of an IMG tag causes that URL to be called. Each time a new log must be sent, the SRC property of the IMG tag is set to the URL of that log posting. The server log URL contains semi-colon-delimited list of tracking parameters, as follows:
tx: transaction id (used to match up to ad impressions)
it: interaction time in seconds (decimal)
vt: view time in seconds (rounded to nearest second)
ic: interaction count
atf: above-the-fold flag (1 if true)
pv: partial view flag (1 if true)
fv: full view flag (1 if true)
seq: sequence number of this log, used to resolve multiple logs when they are processed out of order
et: event type, a letter code indicating what kind of logging event this is, i.e., the reason that a log is being sent. This is used to validate logs and to monitor whether particular log events are reliable or not:
   U=Unload
   H=Hide (previously visible ad is now scrolled out of view)
   V=Visible (previously hidden ad is now visible)
   I=Interaction (an interaction has occurred)
   C=Click
   B=Blur (loss of focus) (Loss of focus is determined by receiving a Blur event from the Javascript engine, which is automatically sent to our event handler when the user switches to a different window.)

The event handlers perform various functions, including one or more of the following. Upon the mouse entering the ad space, the interaction counter is incremented and the interaction timer is started. Upon the mouse leaving the ad space, the interaction clock is stopped, the view clock is stopped, an interaction event is logged, and the scroll position is updated. The scroll position is also updated, as follows. The window dimensions are obtained. Window width and height is retrieved by different methods depending on the type of browser; either window.innerWidth, window.innerHeight; document.documentElement.clientWidth, document.documentElement.clientHeight; or document.body.clientWidth, document.body.clientHeight. The scroll offset (i.e., how far the window has been scrolled from its (0,0) origin) is also determined by different methods depending on the type of browser: window.pageXOffset, window.pageYOffset; or document.body.scrollTop, document.body.scrollLeft; or document.documentElement.scrollTop, document.documentElement.scrollLeft. In addition, it is determined if there are offsets to be accounted for if the containing object is a DIV tag. Once these metrics have been obtained, the following code is executed:

// _r( ) is alias for round( ) function to round numbers...
// me is a reference to the current engagement tracking object
// _ob is the ad object

| | |
|---|---|
| var ws = getWS( ); | // ws[0] is width, ws[1] is height |
| var xy = getXY( ); | //xy[0] is x scroll, xy[1] is y scroll |

```
var y_limit = (_r(me._ps[1]) + _r(me._ob.height)); // account for DIV
var x_limit = (_r(me._ps[0]) + _r(me._ob.width)); // account for DIV
if ( (_r(ws[1]) + _r(xy[1]) >_r(me._ps[1]))
        && (xy[1] < y_limit) &&
        ( (_r(ws[0]) + _r(xy[0]) >_r(me._ps[0]))
        && (xy[0] < x_limit))
        ) {
    if (!me.fV) {
        me.fV = true;
        mL = true;
        if (me.nLg==0) {
            me.fATF=true;
        }
    }
    // if not running, start view clock
    me._vt_1( );
    var fVer=false;
    var fHor=false;
    // check fully visible
    if (me._ps[1] > xy[1] && y_limit < (xy[1] + ws[1]) ) {
        fVer = true;
    }
    if (me._ps[0] > xy[0] && x_limit < (xy[0] + ws[0]) ) {
        fHor = true;
    }
    if ( fHor && fVer ) {
        if (!me.fFV) {
            me.fFV = true;
            mL = true;
        }
    }
} else {
    // not visible, stop view clock if running
    me._vt_0( );
    if ( me._vt > me._vtl ) {
        me._log(“H”);
    }
}
```

The relative position of ad unit in the current viewport is found. If any portion of the ad is within the displayed area of the page, it is flagged as viewed, and the view timer is started if it is not already running. If the ad is fully visible, the FV flag is set to true. If this is the first time running this function, and the ad is fully visible, it is marked as Above the Fold (ATF); otherwise, ATF is always false. If the ad is not visible, the view clock is stopped, and a log is sent if there is pending view data. If it is the first time the function is run, and the ad is at all viewable, a log is sent.

The before unload event is sent when the page is about to be unloaded. The response to this event is to send a final log. Before unload events are not always reliable (e.g., Safari/Mac does not allow logs to be sent during a before unload event, even though the event itself is fired).

Logs can be sent on timer events. These are sent only if data has changed since the last log posting. The timer event is there to insure against missed unload events.

The system described above may also be used to track engagement data for ad units loaded from a third party ad server. In this case, the technique is similar to that previously described. An alternative URL is implemented on the host server which instantiates the engagement tracker, but does not load an ad. This alternative URL is called from within the third party creative code immediately following the URL to load the creative (i.e., the ad unit being displayed). Parameters are passed to the alternative URL identifying the third party ad, and its dimensions. The third party ad tag displays the ad unit. The engagement tracker initializes as described above, and then attaches to the third party ad once the page load event is received. The third party creative identifier that was passed to the engagement tracker during initialization is used to identify the third party ad in the logging transaction. An example of such creative code is shown below:

### Example 1

### Original Third Party Creative Code which Loads the Ad

<script src=”http://thirdparty.com/ads/parameters?sz=728×90&id=12345”>
</script>

### Example 2

### Modified Third Party Creative Code, which Loads the Ad and Initializes the Engagement Tracking

```
<script src=”http://thirdparty.com/ads/parameters?sz=728×90&id=12345”>
      </script>
<script src=”a.hostentity.net/track/thirdparty/;sz=728×90;id=12345”></
      script>
```

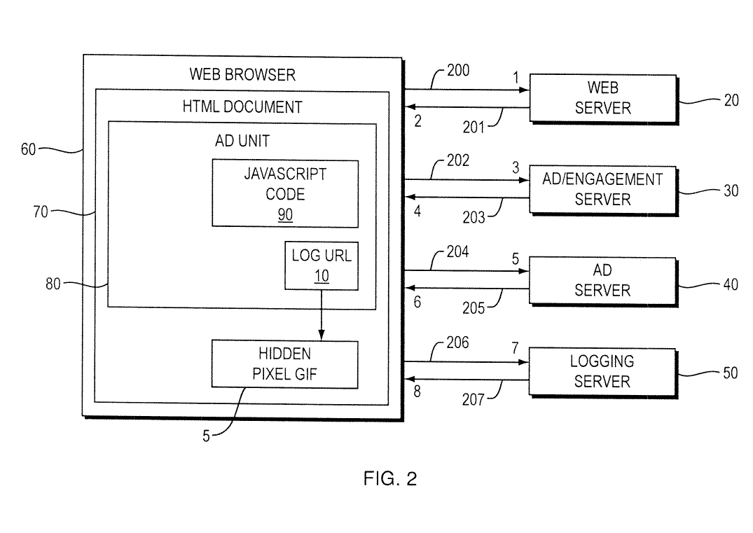

With reference to FIG. 2, the exemplary systems and methods of the present invention are shown. In step 200, an HTTP page load request is sent from the web browser 60 to the web server 20. In step 201, the web server 60 responds with an HTML document 70, including a Javascript ad tag, all of which is rendered by the web browser 60. In step 202, a dynamic Javascript ad tag on the web page 70 causes the browser 60 to request a URL from the ad/engagement server 30. In step 203, the ad/engagement server returns a response containing Javascript code 90 to implement the engagement functionality and load the ad, which is rendered at the tag position and loaded/executed. In step 204, the dynamic Javascript requests the ad URL from the ad server 40. In step 205, the ad server 40 returns the ad creative 80 (e.g., image, Flash object, etc.) which is rendered on the page by the browser 60, and tracked by the engagement code 90. In step 206, the running engagement Javascript code 90 sends logs 10 to an external logging server 50, by dynamically creating an image object at the end of the document body, and setting its SRC property to a URL that calls the logging server. External logging server 50 returns a dummy response of a 0×0 or 1×1 pixel gif, to satisfy HTTP, after logging the contents of the URL.

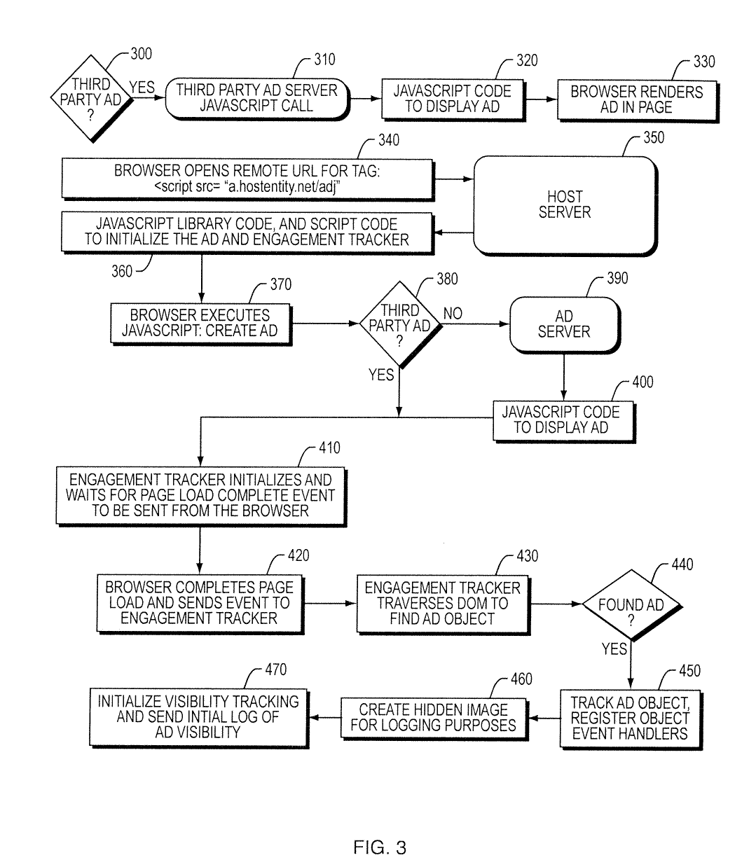

FIG. 3 is a flow chart illustrating an example of a process for tracking engagement metrics. The process begins when a web browser begins to process a Javascript ad tag embedded in a web page. In step 300, it is determined if it is a third party ad. If so, a Javascript call is made to third party ad server in step 310. The Javascript code is used to display the ad in step 320 and the browser renders the ad in the page in step 330. In step 340, the browser opens the remote URL for the tag, in this example <script src=“a.hostentity.net/adj/site/;sz=300×250:></script>. Host server is contacted in step 350 and returns the Javascript library code, and script code, to initialize the ad and engagement tracking module in step 360. In step 370, the browser executes the Javascript to create the ad. In step 380, it is determined if the ad is a third party ad. If not, the ad server is contacted in step 390, and the Javascript code is used to display the ad in step 400. In step 410, the engagement tracker initializes and waits for the page load complete event to be sent from the browser. In step 420, the browser completes the page load and sends the event to the engagement tracking module. In step 430, the engagement tracking module traverses the DOM to find the ad object. In step 440, it is determined if the ad is found. If so, in step 450, the ad object is tracked and object event handlers are registered. In step 460, a hidden image is created for logging purposes. In step 470, visibility tracking is initialized and the initial log of ad visibility is sent.

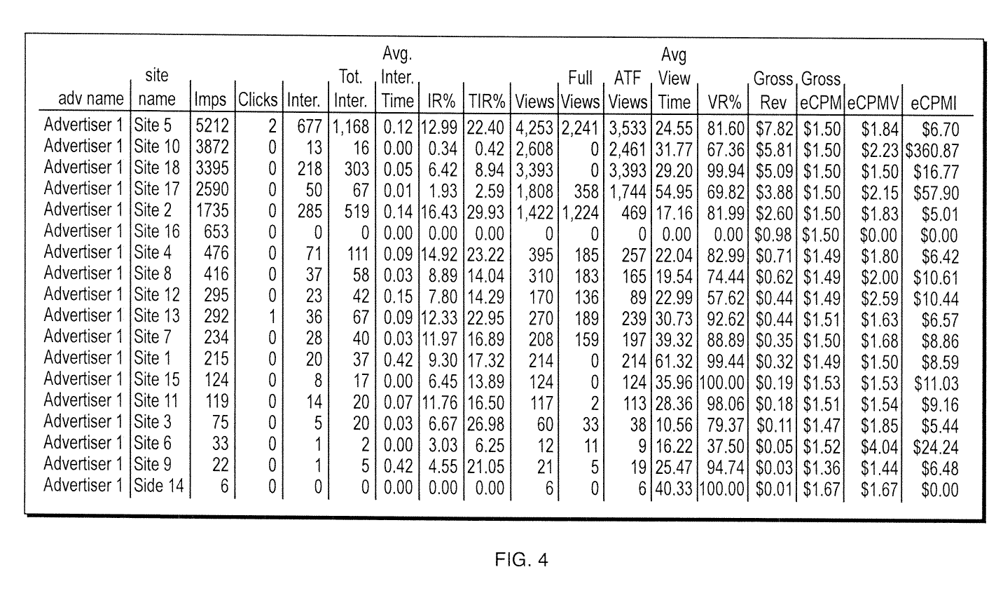

The metrics gathered in accordance with the systems and methods described herein may be stored in a database, such that they may then be displayed in aggregate to show the total and average engagement statistics for particular ads, advertisers, and sites, by way of example. An exemplary report is shown and described in the attached FIG. 4. The columns shown in the report above are as follows: total impressions; total clicks; interactions, the number of impressions where any interaction was measured; total interactions, the sum of all interactions, which may be multiple for any given impression; average interaction time, the sum of the interaction time divided by the sum of impressions; interaction rate, interactions/impressions as a percentage; total interaction rate, total interactions/impressions as a percentage; views, sum of view count; full views, sum of full view count; sum of above the fold view count; total view time/impressions; view rate, views/impressions as a percentage; gross revenue; gross revenue/impressions*1000 (industry standard metric); gross revenue/views*1000; and gross revenue/interactions*1000.

The example of FIG. 4 shows engagement data for a single day's ad impressions aggregated by advertiser. Multiple different aggregations are available (e.g., Advertiser, Order, Ad, Creative, Site, Zone, Context, Behavioral Segment). By aggregating engagement data according to these different data dimensions, it is possible to see patterns and compare metrics based on multiple different criteria, and thereby draw conclusions as to the effectiveness of a particular ad or audience.

It will be apparent to those skilled in the art that various modifications and variations can be made in connection with the system and method of the present invention without departing form the spirit or scope of the invention. Thus, it is intended that the present invention cover the modifications and variations of this invention provided they come within the scope of the appended claims and their equivalents.

What is claimed is:

1. A computer implemented method comprising:
(A) receiving at a server, from a web browser rendering a web page comprising an ad tag, a request for an advertising unit to be displayed on the web page, the advertising unit having a size and a position relative to other objects within the web page;
(B) generating an identifier associated with an instance of the advertising unit displayed on the web page; and
(C) returning a response to the web browser, the response comprising an engagement tracking module,
wherein, upon receiving an indication that the web page has been loaded in the browser, the engagement tracking module identifies the advertising unit based on the size of the advertising unit, the position relative to other objects within the web page, and the identifier and tracks data regarding engagement with the advertising unit by a user of the browser.

2. The method of claim 1 further comprising:
(D) receiving a plurality of logs comprising the data regarding engagement with the advertising unit by the user, wherein the logs are created using an image object embedded within the web page by the engagement tracker, which image object associated with the identifier associated with the advertising unit.

3. A system comprising:
one or more servers that
receive, from a web browser rendering a web page comprising an ad tag, a request for an advertising unit to be displayed on the web page, the advertising unit having a size and a position relative to other objects within the web page;
generate an identifier associated with an instance of the advertising unit displayed on the web page; and
return a response to the web browser, the response comprising an engagement tracking module,
wherein, upon receiving an indication that the web page has been loaded in the browser, the engagement tracking module identifies the advertising unit based on the size of the advertising unit, the position relative to other objects within the web page, and the identifier and tracks data regarding engagement with the advertising unit by a user of the browser.

4. The system of claim 3 further comprising:
one or more databases that store a plurality of logs comprising the data regarding engagement with the advertising unit by the user, wherein the logs are created using an image object embedded within the web page by the engagement tracker, which image object associated with the identifier associated with the advertising unit.

5. A computer-readable storage medium having stored thereon instructions which, when executed by a processor, cause the processor to perform a method comprising:
receiving an indication that a web page has been loaded in a web browser, the web page comprising an ad tag associated with an advertising unit to be displayed on the web page, the advertising unit having a size and a position relative to other objects within the web page and being associated with an identifier;
identifying the advertising unit based on the size of the advertising unit, the position relative to other objects within the web page, and the identifier; and
tracking data regarding engagement with the advertising unit by a user of the browser.
